(19) United States
(12) Patent Application Publication
(10) Pub. No.: US 2023/0184117 A1
(43) Pub. Date: Jun. 15, 2023

(54) AIRFOIL VIBRATION DAMPING APPARATUS

(71) Applicant: General Electric Company, Schenectady, NY (US)

(72) Inventors: Li Zheng, Niskayuna, NY (US); Nicholas J. Kray, Evendale, OH (US); Changjie Sun, Clifton Park, NY (US)

(21) Appl. No.: 17/550,791

(22) Filed: Dec. 14, 2021

(51) Int. Cl. F01D 5/16; F16F 15/173

(52) U.S. Cl. CPC F01D 5/16; F16F 15/173; F16F 2232/02; F16F 2236/106; F16F 2222/08; F16F 2224/041; F05D 2220/36

(57) ABSTRACT

Airfoil vibration damping apparatus are disclosed. An example apparatus includes a metallic airfoil including a cavity, and a dilatant material disposed in the cavity to dampen vibrations of the metallic airfoil.

### FIELD OF THE DISCLOSURE

This disclosure relates generally to aircraft engines and, more particularly, to metallic airfoil damping apparatus.

### BACKGROUND

Gas turbine engines can operate in a variety of environmental conditions. As air passes through a gas turbine engine, blades in the gas turbine engine often encounter different aerodynamic loads. For example, engine blades may experience different aerodynamic loads as the gas turbine engine increases thrust, operates at higher altitudes, and/or encounters ice build-up. Such differing aerodynamic loads may cause stress on the fan blades or other engine parts.

### BRIEF DESCRIPTION OF THE DRAWINGS

FIG. 1 illustrates a schematic cross-sectional view of a prior art example of a turbofan engine.

FIG. 2 illustrates an isolated view of a prior art example fan blade of the turbofan engine of FIG. 1.

FIG. 3A illustrates a first view of a first example implementation of an example airfoil vibration damping apparatus in accordance with the teachings disclosed herein.

FIG. 3B illustrates a second view of the first example implementation of the airfoil vibration damping apparatus.

FIG. 4A-B illustrates a first view of a second example implementation of the airfoil vibration damping apparatus.

FIG. 4B illustrates a second view of the second example implementation of the airfoil vibration damping apparatus.

FIG. 4C illustrates a first example magnified view of the airfoil damping apparatus of FIGS. 4A-B.

FIG. 4D illustrates a second example magnified view of the airfoil damping apparatus of FIGS. 4A-B.

FIG. 5A illustrates a third example implementation of an example airfoil vibration damping apparatus.

FIG. 5B illustrates a fourth example implementation of an example airfoil vibration damping apparatus.

FIG. 6 illustrates a fifth example implementation of an example airfoil vibration damping apparatus.

FIG. 7A illustrates a sixth example implementation of an example airfoil vibration damping apparatus

FIGS. 7B illustrates a seventh example implementation of an example airfoil vibration damping apparatus.

FIG. 7C illustrates an eighth example implementation of an example airfoil vibration damping apparatus

FIG. 7D illustrates a ninth example implementation of an example airfoil vibration damping apparatus.

FIG. 8A illustrates a tenth example implementation of an example airfoil vibration damping apparatus.

FIG. 8B illustrates an eleventh example implementation of an example airfoil vibration damping apparatus.

FIG. 8C illustrates a twelfth example implementation of an example airfoil vibration damping apparatus.

FIG. 8D illustrates a thirteenth example implementation of an example airfoil vibration damping apparatus.

FIG. 8E illustrates a fourteenth example implementation of an example airfoil vibration damping apparatus.

FIG. 8F illustrates a fifteenth example implementation of an example airfoil vibration damping apparatus.

FIG. 9 illustrates a sixteenth example implementation of an example airfoil vibration damping apparatus.

FIG. 10A illustrates a seventeenth example implementation of an example airfoil vibration damping apparatus.

FIG. 10B illustrates an eighteenth example implementation of an example airfoil vibration damping apparatus.

FIG. 10C illustrates a nineteenth example implementation of an example airfoil vibration damping apparatus.

The figures are not to scale. In general, the same reference numbers will be used throughout the drawing(s) and accompanying written description to refer to the same or like parts.

### DETAILED DESCRIPTION

Fan blades of a gas turbine engine can vibrate when the fan blades are in motion. In some instances, fan blade vibrations are caused by lubrication deterioration between the fan blade and a retaining pin that couples the fan blade to a disk. Specifically, the lubrication deterioration causes the fan blade to become stuck on the retaining pin, which prevents the fan blade from rotating about the retaining pin into a natural spinning position determined by centrifugal force as the disk rotates. That is, when the fan blade is stuck to the retaining pin, the centrifugal force may not act on a center of gravity of the fan blade, which can cause an imbalance in the load encountered by the fan blade resulting in a vibration. In other instances, the fan blade may resonate due to aerodynamic forces exciting natural frequency modes of the fan blade, which can cause high-amplitude vibrations that may cause blade damage.

In turn, the vibration of the fan blade can increase a noise output of the turbofan engine. Additionally, the vibration of the fan blade can reduce a consistency and/or an efficiency of airflow through the turbofan engine, which reduces a reliability of the turbofan engine. Moreover, when fan blades encounter high cycle fatigue as a result of vibrations, the fan blades can crack and/or fracture. Accordingly, maintenance is required for fan blades that encounter repetitive vibrations to reduce instances where the fan blades detach from an associated disk and cause further damage to the turbofan engine.

To increase the stability of the fan blades and counteract the vibrations, fan blades typically include platform dampers and/or shrouds. For instance, platform dampers can be positioned underneath blade platforms of adjacent fan blades and can press against the platforms in response to encountering a centrifugal force via a rotation of the disk. In turn, the platform damper can create friction when the blade platforms move relative to each other, which dampens vibrations at the platforms. However, platform dampers can be less effective in blades that have a reduced weight as the centrifugal force encountered by the associated platform is reduced, which reduces friction against the platform damper.

In some instances, shrouds can be at a tip of the blade (e.g., a tip-shroud) or at a partial span between a hub of the blade and the tip (e.g., a part-span shroud). Partial span and tip shrouds contact adjacent blades and provide damping when the shrouds rub against each other. However, shrouds obstruct a flow path between adjacent fan blades, which reduces a mass flow rate between the fan blades and, in turn, reduces a thrust produced by the turbofan engine. Tip-shrouds need a large tip fillet to reduce stress concentrations, which creates tip losses as geometries of the tip shrouds can reduce an efficiency of the airflow through the turbine engine.

Examples disclosed herein provide airfoil vibration damping apparatus. The airfoil vibration damping apparatus includes a dilatant material (e.g., a shear-thickening fluid) or a low modulus material disposed in a cavity of an airfoil to dampen vibrations of the airfoil. Specifically, the airfoil encounters shear stresses in response to vibrations, which causes the dilatant material to thicken and, in turn, increase a stiffness of the airfoil. Moreover, in response to thickening, the dilatant material exerts a force against an interior surface of the cavity that counteracts the vibrations and reduces a magnitude of the shear stresses encountered by the airfoil.

In some examples, the airfoil includes cells (e.g., sub-cavities) to contain the dilatant material. In some examples, the cells span throughout the cavity of the airfoil. In some examples, the cells span across a surface of the cavity. In some examples, the cells span across a portion of the surface of the cavity that encounters increased shear stresses when the airfoil encounters unsteady aerodynamic loads. In some examples, the dilatant material is disposed in one or more of the cells.

In some examples, the airfoil includes one or more lattice structures, and/or baffles in the cavity to direct flow of the dilatant material. In some examples, the lattice structure(s) and/or the baffles increase the shear stresses encountered by the dilatant material and, thus, increase stabilizing forces provided by the dilatant material when the airfoil encounters vibrations. In some examples, the lattice structure(s) and/or the baffles increase shear stresses encountered by the dilatant material in certain areas of the cavity of the airfoil. As such, the lattice structures and/or the baffles can cause the dilatant material to have an increased thickness and, thus, provide increased vibration attenuation to a portion of the airfoil that encounters vibrations of greater magnitudes.

In certain examples, a wear-resistant coating surrounds the dilatant material to minimize or otherwise reduce wear encountered by the airfoil and structures positioned in the cavity of the airfoil, such as walls of the sub-cavities, the baffles, and/or lattice structure(s). In certain examples, the wear-resistant coating includes titanium, aluminum, and/or cobalt. For example, the wear-resistant coating can include at least one of titanium-aluminum-chromium, titanium-aluminum-chromium-yttrium-silicon, titanium-aluminum-niobium-tantalum, cobalt-molybdenum-chromium, and/or cobalt-chromium-tungsten-nickel. In certain examples, the wear-resistant coating includes one or more high-entropy alloys and/or a bulk metallic glass.

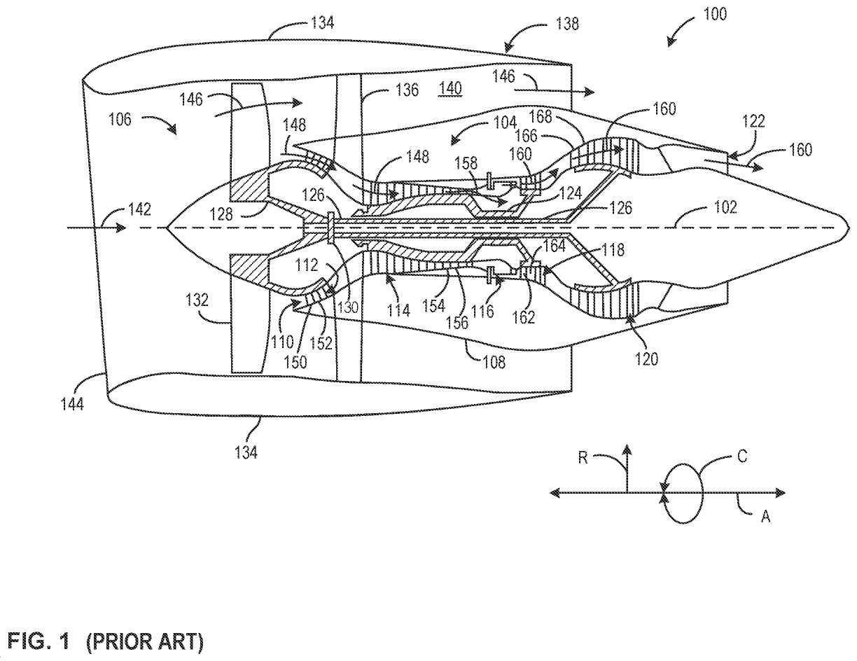

Referring now to the drawings, FIG. 1 is a schematic cross-sectional view of a prior art example of a turbofan engine 100 that may incorporate various examples disclosed herein. As shown in FIG. 1, the turbofan engine 100 defines a longitudinal or axial centerline axis 102 extending therethrough for reference. In general, the turbofan engine 100 can include a core turbine or a core turbine engine 104 disposed downstream from a fan section 106.

The core turbine engine 104 can generally include a substantially tubular outer casing 108 that defines an annular inlet 110. The outer casing 108 can be formed from multiple solid segments. The outer casing 108 encloses, in serial flow relationship, a compressor section having a booster or low-pressure compressor 112 (“LP compressor 112”) and a high-pressure compressor 114 (“HP compressor 114”), a combustion section 116, a turbine section having a high-pressure turbine 118 (“HP turbine 118”) and a low-pressure turbine 120 (“LP turbine 120”), and an exhaust section 122. A high-pressure shaft or spool 124 (“HP shaft 124”) drivingly couples the HP turbine 118 and the HP compressor 114. A low-pressure shaft or spool 126 (“LP shaft 126”) drivingly couples the LP turbine 120 and the LP compressor 112. The LP shaft 126 can also couple to a fan shaft or spool 128 of the fan section 106. In some examples, the LP shaft 126 can couple directly to the fan shaft 128 (i.e., a direct-drive configuration). In alternative configurations, the LP shaft 126 may couple to the fan shaft 128 via a reduction gearbox 130 (i.e., an indirect-drive or geared-drive configuration).

As shown in FIG. 1, the fan section 106 includes a fan 132 coupled to and extending radially outwardly from the fan shaft 128. An annular fan casing or nacelle 134 circumferentially encloses the fan section 106 and/or at least a portion of the core turbine engine 104. The nacelle 134 can be supported relative to the core turbine engine 104 by a forward mount 136. Furthermore, a downstream section 138 of the nacelle 134 can enclose an outer portion of the core turbine engine 104 to define a bypass airflow passage 140 therebetween.

As illustrated in FIG. 1, air 142 enters an intake or inlet portion 144 of the turbofan engine 100 during operation thereof. A first portion 146 of the air 142 flows into the bypass airflow passage 140, while a second portion 148 of the air 142 flows into the annular inlet 110 of the LP compressor 112. One or more sequential stages of LP compressor stator vanes 150 and LP compressor rotor blades 152 (e.g., turbine blades) coupled to the LP shaft 126 progressively compress the second portion 148 of the air 142 flowing through the LP compressor 112 en route to the HP compressor 114. Next, one or more sequential stages of HP compressor stator vanes 154 and HP compressor rotor blades 156 coupled to the HP shaft 124 further compress the second portion 148 of the air 142 flowing through the HP compressor 114. This provides compressed air 158 to the combustion section 116 where it mixes with fuel and burns to provide combustion gases 160.

The combustion gases 160 flow through the HP turbine 118 where one or more sequential stages of HP turbine stator vanes 162 and HP turbine rotor blades 164 coupled to the HP shaft 124 extract a first portion of kinetic and/or thermal energy therefrom. This energy extraction supports operation of the HP compressor 114. The combustion gases 160 then flow through the LP turbine 120 where one or more sequential stages of LP turbine stator vanes 166 and LP turbine rotor blades 168 coupled to the LP shaft 126 extract a second portion of thermal and/or kinetic energy therefrom. This energy extraction causes the LP shaft 126 to rotate, thereby supporting operation of the LP compressor 112 and/or rotation of the fan shaft 128. The combustion gases 160 then exit the core turbine engine 104 through the exhaust section 122 thereof.

Along with the turbofan engine 100, the core turbine engine 104 serves a similar purpose and sees a similar environment in land-based turbines, turbojet engines in which the ratio of the first portion 146 of the air 142 to the second portion 148 of the air 142 is less than that of a turbofan, and unducted fan engines in which the fan section 106 is devoid of the nacelle 134. In each of the turbofan, turbojet, and unducted engines, a speed reduction device (e.g., the reduction gearbox 130) can be included between any shafts and spools. For example, the reduction gearbox 130 can be disposed between the LP shaft 126 and the fan shaft 128 of the fan section 106.

As depicted therein, the turbofan engine 100 defines an axial direction A, a radial direction R, and a circumferential direction C. In general, the axial direction A extends generally parallel to the axial centerline axis 102, the radial direction R extends orthogonally outward from the axial centerline axis 102, and the circumferential direction C extends concentrically around the axial centerline axis 102.

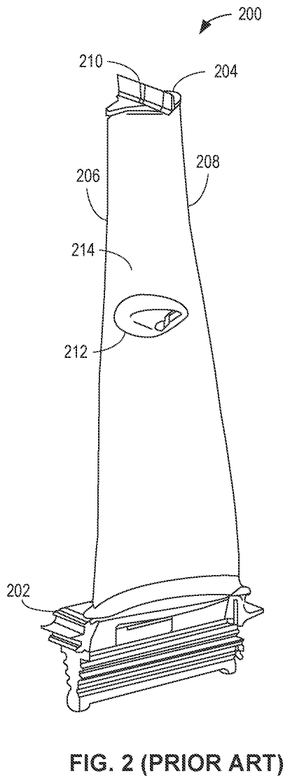

FIG. 2 illustrates an airfoil 200 of the fan 132 of FIG. 1. In the illustrated example of FIG. 2, the airfoil 200 extends from a root portion 202 to a tip portion 204, and from a leading axial edge 206 to a trailing axial edge 208. The root portion 202 can be coupled to the fan shaft 128 of FIG. 1 to enable the airfoil 200 to rotate. In FIG. 2, the airfoil 200 includes a tip shroud 210 extending from the tip portion 204. In FIG. 2, the airfoil 200 includes a partial span shroud 212 extending from a sidewall 214 of the airfoil 200. Additionally, the airfoil 200 can include another partial span shroud (not shown) extending from a sidewall of the airfoil opposite the sidewall 214 of FIG. 2.

Accordingly, the tip shroud 210 and the partial span shroud 212 can cause the airfoil 200 to encounter friction in response to vibrating, which dampens the vibrations. However, the tip shroud 210 and the partial span shroud 212 occupy space between the airfoil 200 and an adjacent airfoil in the fan 132, which reduces a mass flow rate of air that passes between the airfoil 200 and the adjacent airfoil as the fan 132 rotates. As such, although the tip shroud 210 and the partial span shroud 212 may dampen vibrations of the airfoil 200, a thrust produced by the turbofan engine 100 is reduced.

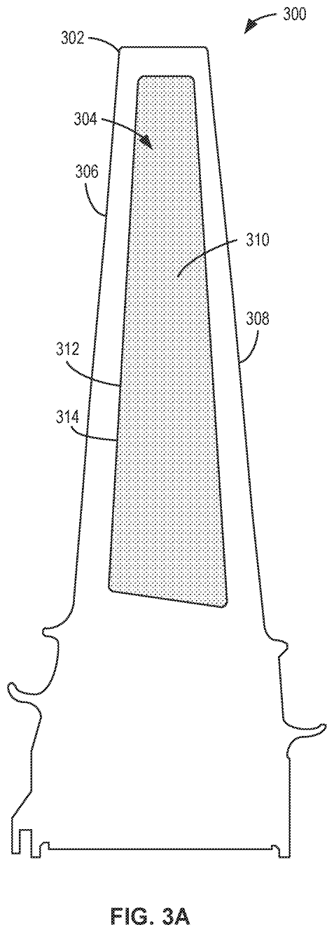

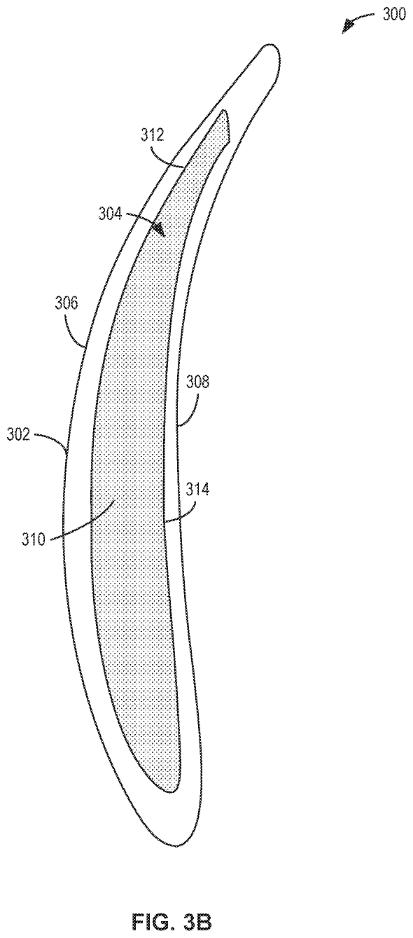

FIG. 3A illustrates a side view of a first example airfoil damping apparatus 300 in accordance with the teachings of this disclosure. FIG. 3B illustrates an example radially-inward view of the first example airfoil damping apparatus 300. In FIGS. 3A-B, the first example airfoil damping apparatus 300 includes an airfoil 302 (e.g., a hollow fan blade). For example, the airfoil 302 can be implemented in the fan 132 of the turbofan engine 100 of FIG. 1. The airfoil damping apparatus 300 increases vibration damping of the airfoil 302 over the prior art airfoil 200 of FIG. 2. Additionally, the airfoil damping apparatus 300 enables a mass flow rate of air that passes between the airfoil 302 and an adjacent airfoil (e.g., in the fan 132) to be increased during rotation compared to the airfoil 200 of FIG. 2 as a protrusion(s) (e.g., the tip shroud 210, the partial span shroud 212) is not required to dampen vibrations of the airfoil 302.

The airfoil 302 includes an internal cavity 304 between a leading edge 306 and a trailing edge 308 of the airfoil 302. In FIGS. 3A-B, the airfoil 302 includes a dilatant material 310 (e.g., a shear-thickening fluid, a low modulus material, etc.) disposed in the internal cavity 304. The dilatant material 310 can include solid particles dispersed in a fluid (e.g., silica nano-particles dispersed in polyethylene glycol, Armourgel®, etc.). When the airfoil 302 is stable, the solid particles in the dilatant material 310 encounter electrostatic or steric forces that overcome interparticle forces (e.g., Hamaker attraction forces, Van der Waals forces) between the solid particles, which prevents the solid particles from approaching each other.

In FIGS. 3A-B, when the airfoil 302 encounters vibrations, the airfoil 302 encounters shear stresses, which cause the dilatant material 310 to encounter shear strain in the internal cavity 304. When the shear stress or strain encountered by the dilatant material 310 surpasses a threshold (e.g., a critical shear rate) associated with the dilatant material 310, the solid particles approach each other and, in turn, the interparticle forces overcome the electrostatic or steric forces. That is, the solid particles in the dilatant material 310 encounter flocculation, which causes the solid particles to clump together. In turn, a thickness and viscosity of the dilatant material 310 increases as the dilatant material 310 behaves more like a solid. As a result, the dilatant material 310 provides a resisting force on a surface 312 of the internal cavity 304 that acts against the vibratory movements of the airfoil 302 and, thus, stabilizes the airfoil 302.

In some examples, the thickness and viscosity of the dilatant material 310 and, thus, the resistance to vibrations provided by the dilatant material 310 is based on a size and/or a quantity of the solid particles in the dilatant material 310. As such, in turbofan engines that have multistage fans, a first dilatant material (e.g., the dilatant material 310) having more solid particles and/or larger solid particles can be utilized in a first row of fan blades that encounters more vibrations, and a second dilatant material having fewer solid particles and/or smaller solid particles can be utilized in a second row of fan blades that encounters less vibrations than the first row of fan blades. Additionally or alternatively, when a first portion of the airfoil 302 tends to encounter more vibrations than a second portion of the airfoil 302, a first portion of the internal cavity 304 can include the first dilatant material and a second portion of the internal cavity 304 can include the second dilatant material.

In FIGS. 3A-B, the surface 312 of the internal cavity includes a wear-resistant coating 314. As such, the wear-resistant coating 314 minimizes or otherwise reduces wear that results from friction between the surface 312 and the dilatant material 310 when the dilatant material 310 behaves more like a solid in response to vibrations. In some examples, the wear-resistant coating 314 includes titanium, cobalt, and/or aluminum. For example, the wear-resistant coating 314 can include titanium-aluminum-chromium, titanium-aluminum-chromium-yttrium-silicon, titanium-aluminum-niobium-tantalum, cobalt-molybdenum-chromium, and/or cobalt-chromium-tungsten-nickel. In some examples, the wear-resistant coating 314 includes one or more high entropy alloys and/or a bulk metallic glass. In some examples, the wear-resistant coating 314 includes a thickness between 0.01 centimeters (cm) and 0.10 cm. In some examples, the airfoil damping apparatus 300 is formed via additive manufacturing and/or diffusion bonding. In some examples, the airfoil damping apparatus 300 is formed via machined pockets with an attached cover plate. However, other conventional manufacturing techniques may additionally or alternatively be used to form the airfoil damping apparatus 300.

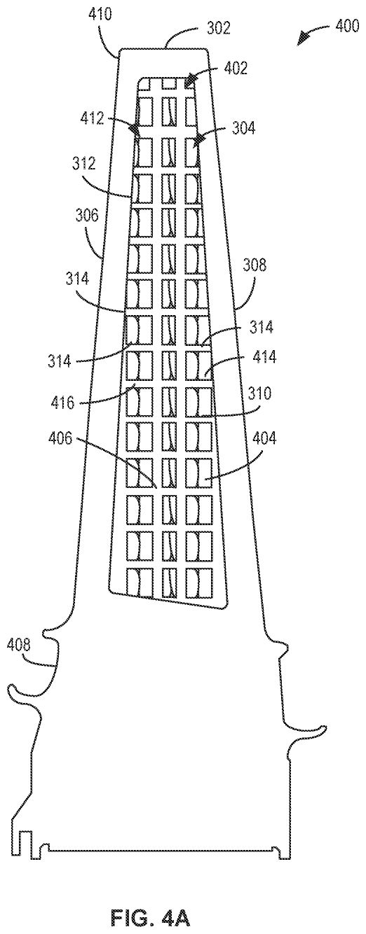

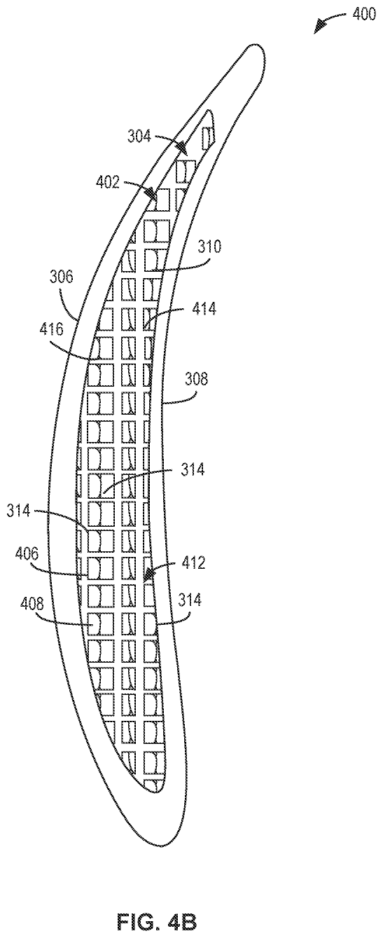

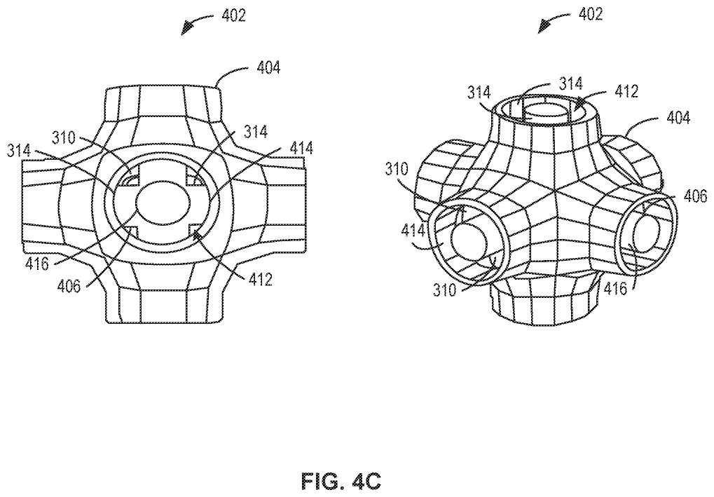

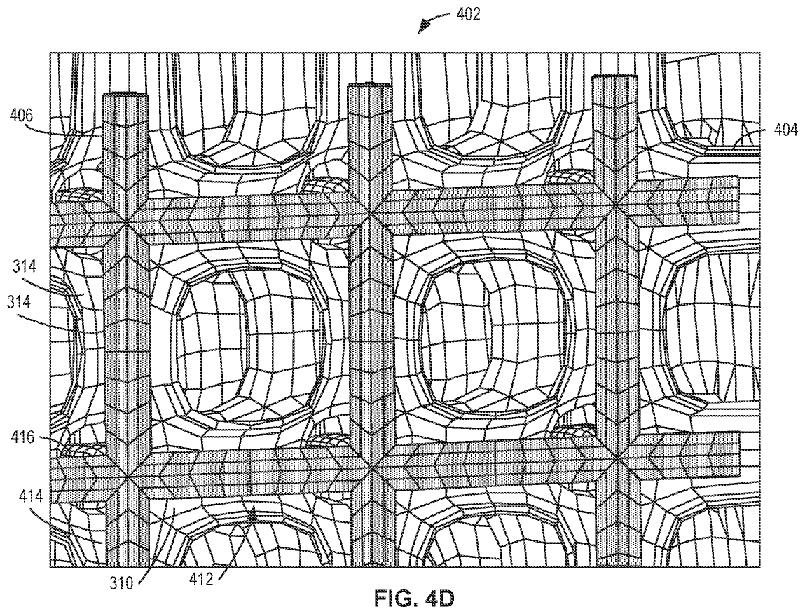

FIG. 4A illustrates a side view of a second example airfoil damping apparatus 400 in accordance with the teachings of this disclosure. FIG. 4B illustrates an example radially-inward view of the second example airfoil damping apparatus 400. In FIGS. 4A-B, the second example airfoil damping apparatus 400 includes a nested lattice structure 402 coupled to the surface 312 of the internal cavity 304 of the airfoil 302.

FIGS. 4C-D illustrate magnified views of the nested lattice structure 402. In FIGS. 4A-D, the nested lattice structure 402 includes a first lattice structure 404 and a second lattice structure 406. The first lattice structure 404 is coupled to the leading edge 306 and a root portion 408 of the airfoil 302. The second lattice structure 406 is coupled to the trailing edge 308 and a tip portion 410 of the airfoil 302. The first lattice structure 404 is positioned around the second lattice structure 406 to define a passageway 412.

In FIGS. 4A-D, the dilatant material 310 is disposed in the passageway 412. In FIGS. 4A-D, an interior surface 414 of the first lattice structure 404 and a surface 416 of the second lattice structure 406 are coated with the wear-resistant coating 314 to prevent or otherwise reduce wear encountered by the first lattice structure 404 and the second lattice structure 406 as a result of the dilatant material 310 moving in the passageway 412. In some examples, a portion of the surface 312 of the internal cavity 304 that is coupled to the first lattice structure 404 or the second lattice structure 406 and/or defines an end of the passageway 412 also includes the wear-resistant coating 314.

When the airfoil 302 encounters vibrations, the first lattice structure 404 and the second lattice structure 406 move relative to each other. As a result, the dilatant material 310 encounters shear strain, which causes the dilatant material 310 to thicken and, in turn, exert a force against the interior surface 414 of the first lattice structure 404 and the surface 416 of the second lattice structure 406. Specifically, the force produced by the dilatant material 310 counteracts the movement of the first lattice structure 404 relative to the second lattice structure 406. As such, the dilatant material 310 stabilizes the first lattice structure 404 and the second lattice structure 406. Moreover, because the first lattice structure 404 is coupled to the leading edge 306 and the root portion 408 while the second lattice structure 406 is coupled to the trailing edge 308 and the tip portion 410, the force provided by the dilatant material 310 counteracts movement between the leading edge 306 and the trailing edge 308 of the airfoil 302 and/or the root portion 408 and the tip portion 410 to attenuate vibrations and stabilize the airfoil 302.

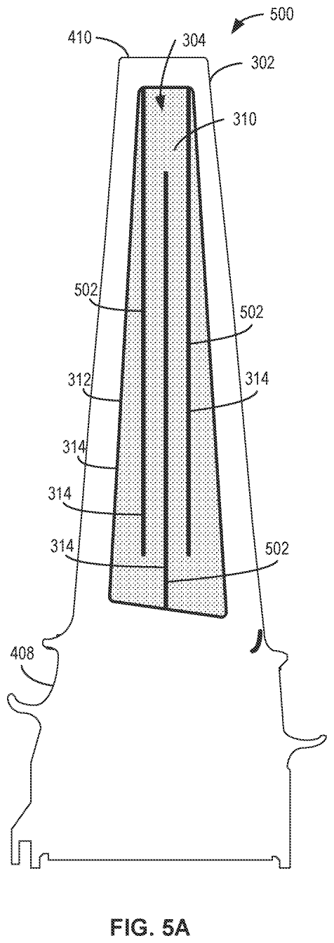

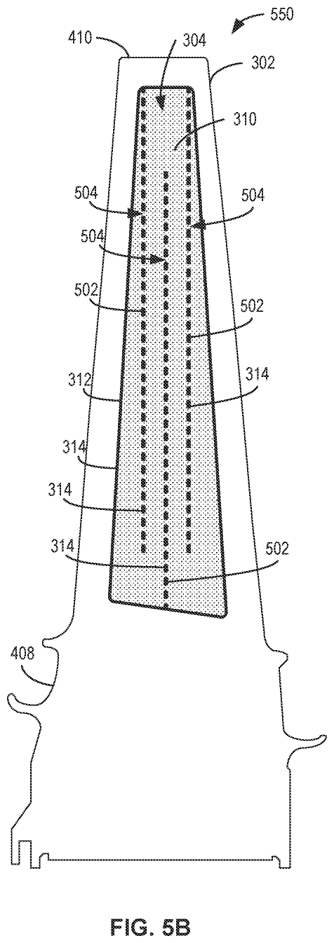

FIG. 5A illustrates a side view of a third example airfoil damping apparatus 500 in accordance with the teachings of this disclosure. FIG. 5B illustrates a side view of a fourth example airfoil damping apparatus 550 in accordance with the teachings of this disclosure. In FIGS. 5A-B, the internal cavity 304 of the airfoil 302 includes baffles 502 that guide movement of the dilatant material 310 within the internal cavity 304. In some examples, the baffles 502 are solid, as shown in FIG. 5A. In some examples, the baffles 502 include perforations 504, as shown in FIG. 5B. In FIGS. 5A-B, the baffles 502 span along a chordwise direction defined by the airfoil 302. In FIGS. 5A-B, adjacent ones of the baffles 502 alternate between being coupled to the tip portion 410 of the airfoil 302 and the root portion 408 of the airfoil 302.

In FIGS. 5A-B, the baffles 502 increase the shear stress and strain encountered by the dilatant material 310 when the airfoil 302 encounters chordwise bending and vibrations. In turn, the baffles 502 cause the dilatant material 310 to have an increased viscosity and/or thickness when the airfoil 302 encounters chordwise vibrations. Additionally, the baffles 502 cause the viscosity and/or the thickness of the dilatant material 310 to increase at a faster rate in response to the airfoil 302 encountering chordwise vibrations. In FIG. 5B, when the airfoil 302 vibrates, the dilatant material 310 is forced through the perforations 504 in the baffles 502, which further increases the shear stress and strain encountered by the dilatant material 310 and, thus, further increases the viscosity of the dilatant material 310 as well as the rate at which the viscosity of the dilatant material 310 increases.

As such, the third example airfoil damping apparatus 500 and the fourth example airfoil damping apparatus 550 provide increased vibration damping in response to chordwise vibrations. Accordingly, the third example airfoil damping apparatus 500 and/or the fourth example airfoil damping apparatus 550 may be utilized with certain airfoils that include a structure that encounters more chordwise bending. Additionally or alternatively, the third example airfoil damping apparatus 500 and/or the fourth example airfoil damping apparatus 550 may be utilized in certain locations in turbofan engines (e.g., the turbofan engine 100 of FIG. 1) that encounter greater imbalanced forces in the chordwise direction.

In FIGS. 5A-B, the baffles 502 and the surface 312 of the internal cavity 304 are coated with the wear-resistant coating 314. As such, the wear-resistant coating 314 prevents the baffles 502 and the surface 312 from encountering wear as a result of friction from movement of the dilatant material 310.

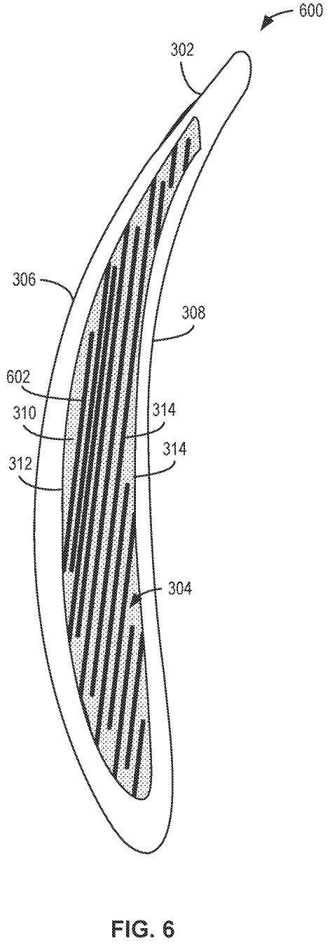

FIG. 6 illustrates an example radially-inward view of a fifth example airfoil damping apparatus 600 in accordance with the teachings of this disclosure. In FIG. 6, the internal cavity 304 of the airfoil 302 includes baffles 602 that direct movement of the dilatant material 310 within the internal cavity 304. In FIG. 6, the baffles 602 span along a chordwise direction defined by the airfoil 302 similar to the baffles 502 of FIGS. 5A and/or 5B. In FIG. 6, adjacent ones of the baffles 602 alternate between being coupled to the leading edge 306 of the airfoil 302 and the trailing edge 308 of the airfoil 302.

In FIG. 6, the baffles 602 increase the shear stress and strain encountered by the dilatant material 310 when the airfoil 302 encounters chordwise bending and vibrations. As a result, the fifth example airfoil damping apparatus 600 provides increased vibration damping in response to chordwise vibrations, similar to the baffles 502 of FIGS. 5A and/or 5B. In FIG. 6, the baffles 602 and the surface 312 of the internal cavity 304 include the wear-resistant coating 314, which prevents the baffles 602 and/or the airfoil 302 from encountering wear as a result of friction from movement of the dilatant material 310.

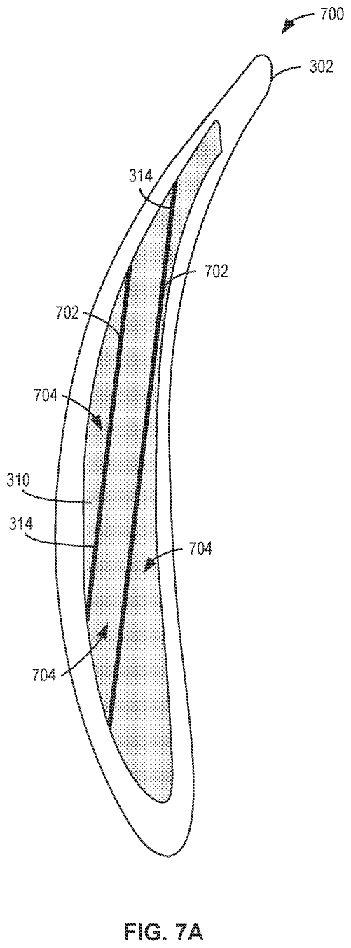

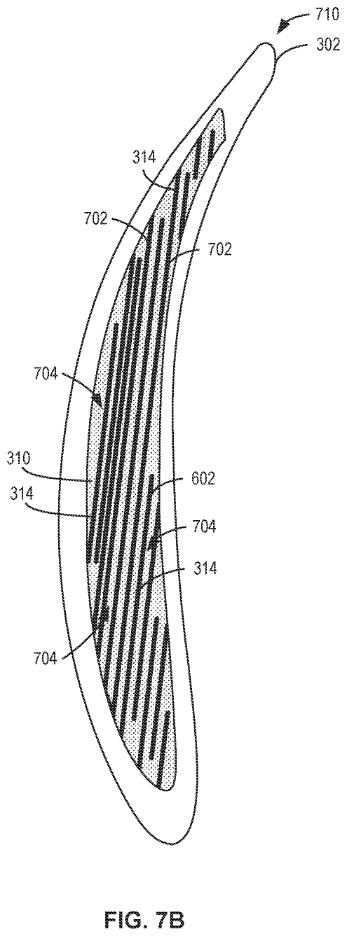

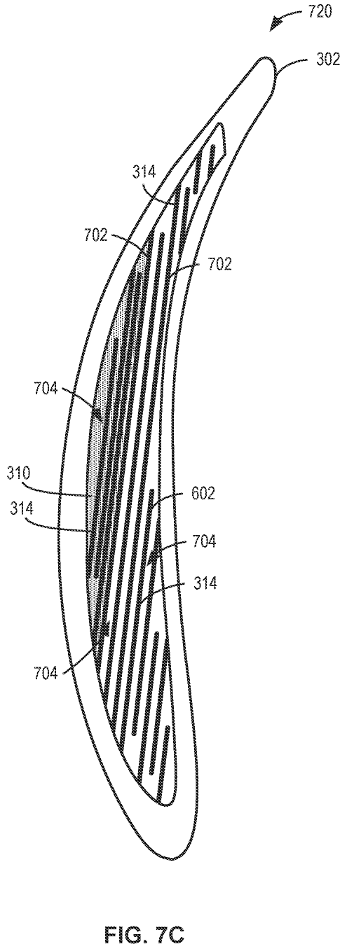

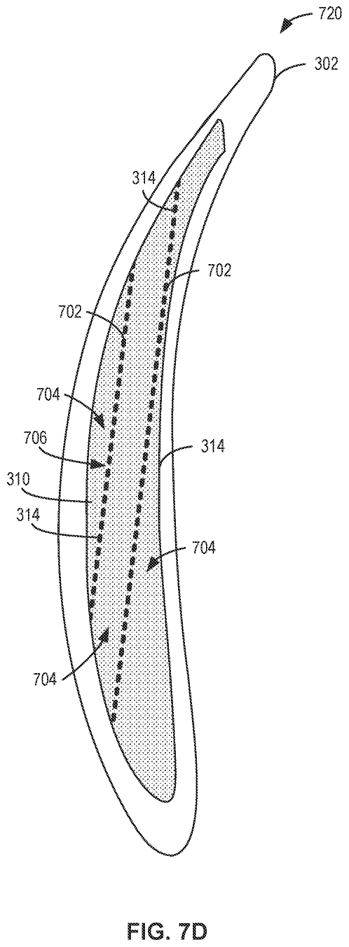

FIG. 7A illustrates a radially-inward view of a sixth example airfoil damping apparatus 700 in accordance with the teachings of this disclosure. FIG. 7B illustrates a radially-inward view of a seventh example airfoil damping apparatus 710 in accordance with the teachings of this disclosure. FIG. 7C illustrates a radially inward view of an eighth example airfoil damping apparatus 720 in accordance with the teachings of this disclosure. In FIGS. 7A-C, the airfoil 302 includes chordwise walls 702 that define chambers 704 (e.g., chordwise cavities, sub-cavities, etc.) filled with the dilatant material 310. In FIGS. 7A-C, the chordwise walls 702 are solid and, thus, the chambers 704 are secluded.

In FIGS. 7B-7C, the airfoil 302 includes the baffles 602 positioned in the chambers 704 to increase shear stresses and strains encountered by the dilatant material 310 in the chambers 704 and, thus, increase vibration damping provided by the dilatant material 310. The dilatant material 310 can be disposed in one or more of the chambers 704 to provide vibration damping. In some examples, all of the chambers 704 include the dilatant material 310, as shown in FIG. 7B. In some examples, a first portion of the airfoil 302 includes the dilatant material 310 and a second portion of the airfoil 302 includes air, as shown in FIG. 7C. In the illustrated example of FIG. 7C, the dilatant material 310 is disposed in one of the chambers 704 and a remainder of the chambers 704 include air. In some examples, a leading one of the chambers 704 and a trailing one of the chambers 704 can be filled with the dilatant material 310 while a middle one of the chambers 704 is filled with air.

FIG. 7D illustrates a radially-inward view of a ninth example airfoil damping apparatus 720. In FIG. 7D, the airfoil 302 includes the chordwise walls 702 that define the chambers 704 filled with the dilatant material 310. In FIG. 7D, the chordwise walls 702 include perforations 706 and, thus, the dilatant material 310 can move between the chambers 704. Additionally, the perforations 706 cause the dilatant material 310 to encounter an increased shear stress and strain in response to moving between the chambers 704.

In FIGS. 7A-D, when the airfoil 302 vibrates, a viscosity and thickness of the dilatant material 310 increases and, in turn, the dilatant material 310 provides a force against the surface 312 of the internal cavity 304 that resists the movement of the airfoil 302 and dampens the vibrations. In FIGS. 7A-D, the chordwise walls 702 along with the surface 312 of the internal cavity 304 are coated with the wear-resistant coating 314.

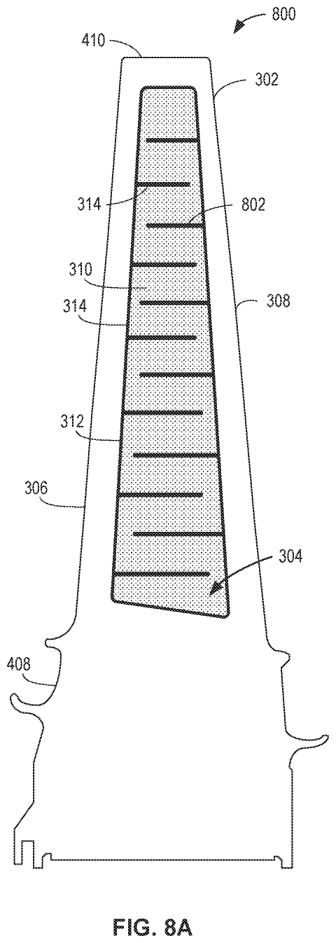

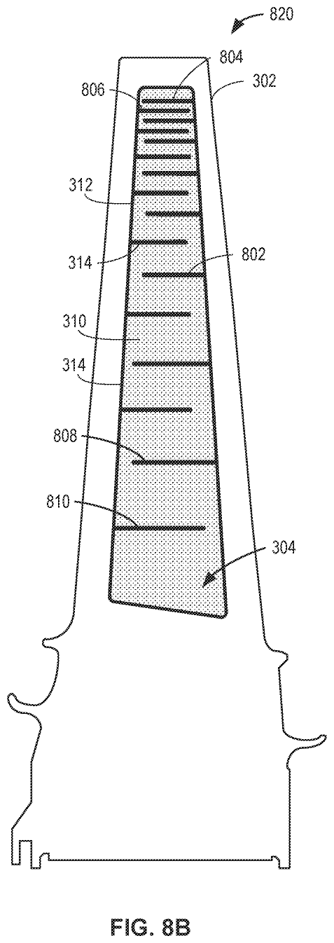

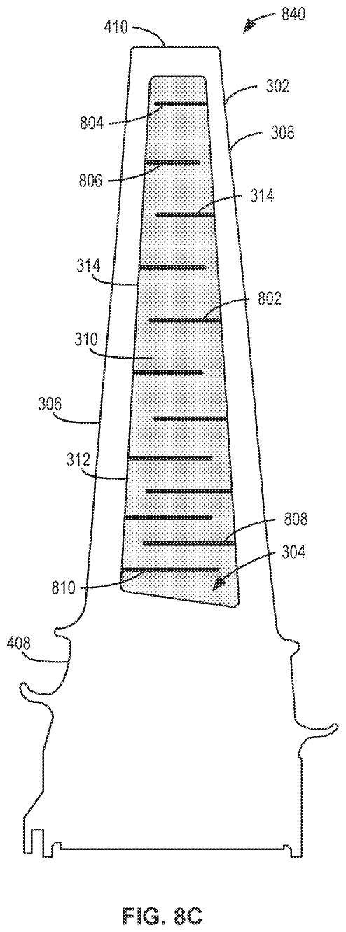

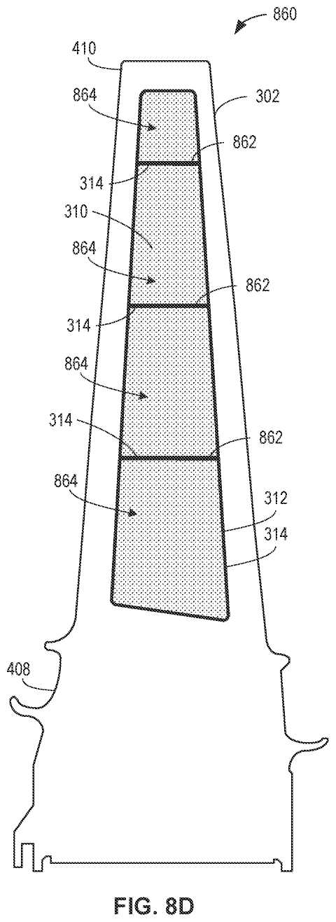

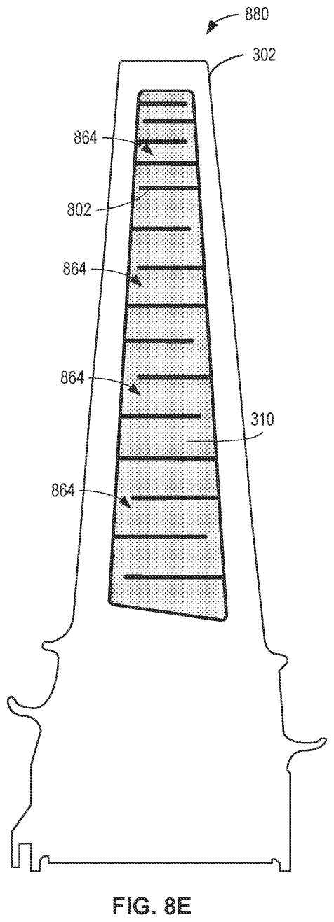

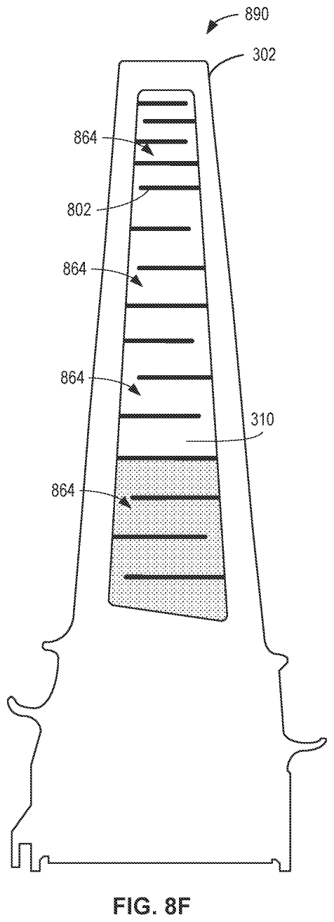

FIG. 8A illustrates a side view of a tenth example airfoil damping apparatus 800. FIG. 8B illustrates a side view of an eleventh example airfoil damping apparatus 820. FIG. 8C illustrates a side view of a twelfth example airfoil damping apparatus 840. In FIGS. 8A-C, the airfoil 302 includes baffles 802 that span in the axial direction of an associated turbofan engine (e.g., the axial direction A of the turbofan engine 100 of FIG. 1) and guide a flow of the dilatant material 310 within the internal cavity 304. In FIGS. 8A-C, adjacent ones of the baffles 802 alternate between being coupled to the leading edge 306 of the airfoil 302 and the trailing edge 308 of the airfoil 302. In FIGS. 8A-C, the baffles 802 and the surface 312 of the internal cavity 304 are coated with the wear-resistant coating 314.

In FIG. 8A, a separation distance between adjacent ones of the baffles 802 is approximately equivalent throughout the internal cavity 304. Accordingly, uniform spacing between the baffles 802 causes the dilatant material 310 to provide uniform vibration attenuation between the root portion 408 of the airfoil 302 and the tip portion 410 of the airfoil 302.

In FIG. 8B, a separation distance between adjacent ones of the baffles 802 is reduced towards the tip portion 410 of the airfoil 302 to enable the dilatant material 310 to provide increased vibration damping towards the tip portion 410. For example, the baffles 802 can include a first baffle 804 adjacent a second baffle 806 and a third baffle 808 adjacent a fourth baffle 810. In FIG. 8B, the first and second baffles 804, 806 are positioned closer to the tip portion 410 than the third baffle 808 and the fourth baffle 810. In FIG. 8B, the first baffle 804 and the second baffle 806 are separated by a first distance, and the third baffle 808 and the fourth baffle 810 are separated by a second distance greater than the first distance. As such, the first baffle 804 and the second baffle 806 cause the dilatant material 310 to encounter greater shear stress and strain than the third baffle 808 and the fourth baffle 810. Thus, in the eleventh example airfoil damping apparatus 820, the dilatant material 310 can include a greater thickness increase towards the tip portion 410 of the airfoil 302, which enables the dilatant material 310 to provide greater vibration damping towards the tip portion 410.

Conversely, in FIG. 8C, the third baffle 808 and the fourth baffle 810 are separated by a third distance, and the first baffle 804 and the second baffle 806 are separated by a fourth distance greater than the third distance. As such, in FIG. 8C, the third baffle 808 and the fourth baffle 810 can cause the dilatant material 310 to encounter greater shear stress and strain than the first baffle 804 and the second baffle 806. Accordingly, in the twelfth example airfoil damping apparatus 840, the dilatant material can include a greater thickness increase towards the root portion 408 of the airfoil 302, which enables the dilatant material to provide greater vibration damping towards the root portion 408.

FIG. 8D illustrates a thirteenth example airfoil damping apparatus 860. In FIG. 8D, the airfoil 302 includes walls 862 that are coupled to the leading edge 306 and the trailing edge 308 of the airfoil 302. In turn, the walls 862 define radially oriented cavities 864 within the airfoil 302. In some examples, the dilatant material 310 is disposed in one or more of the radially oriented cavities 864. In some examples, the dilatant material 310 includes solid particles of a first quantity or a first size in one of the radially oriented cavities 864 and solid particles of a second quantity or a second size in another one of the radially oriented cavities 864. Accordingly, the radially oriented cavities 864 enable the dilatant material 310 to provide localized vibration damping to certain portions of the airfoil 302. In FIG. 8D, the walls 862 along with the surface 312 of the internal cavity 304 are coated with the wear-resistant coating 314.

FIG. 8E illustrates a side view of a fourteenth example airfoil damping apparatus 880. FIG. 8F illustrates a side view of a fifteenth example airfoil damping apparatus 890. In FIGS. 8E-8F, the radially oriented baffles 802 are positioned in the radially oriented cavities 864. Accordingly, the radially oriented baffles 802 increase shear stresses and strains encountered by the dilatant material 310 in the radially oriented cavities 864 and, thus, increase vibration damping provided by the dilatant material 310. The dilatant material 310 can be disposed in one or more of the radially oriented cavities 864 to provide vibration damping. In some examples, all of the radially oriented cavities 864 include the dilatant material 310, as shown in FIG. 8E. In some examples, a first portion of the airfoil 302 includes the dilatant material 310 and a second portion of the airfoil 302 includes air, as shown in FIG. 8F. In the illustrated example of FIG. 8F, the dilatant material 310 is disposed in one of the radially oriented cavities 864 and a remainder of the radially oriented cavities 864 include air.

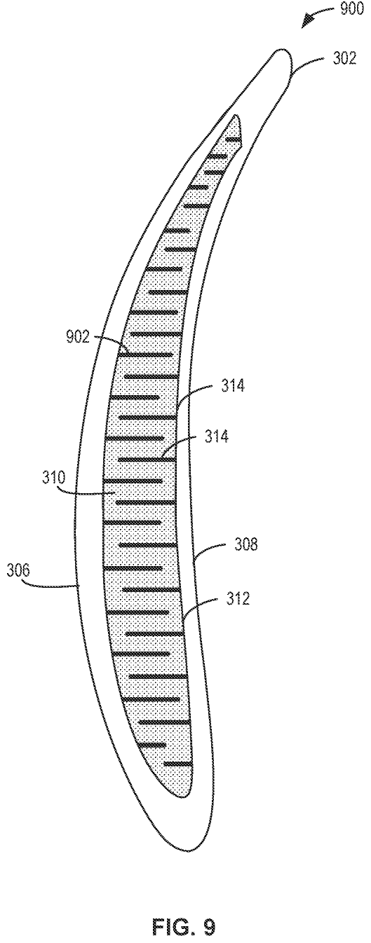

FIG. 9 illustrates a radially-inward view of a sixteenth example airfoil damping apparatus 900. In FIG. 9, the airfoil 302 includes baffles 902 that span in the axial direction of an associated turbofan engine (e.g., the axial direction A of the turbofan engine 100 of FIG. 1) and guide a flow of the dilatant material 310 within the internal cavity 304. In FIG. 9, adjacent ones of the baffles 902 alternate between being coupled to the root portion 408 (not shown) and the tip portion 410 (not shown) of the airfoil 302, as opposed to being coupled to the leading edge 306 and the trailing edge 308 of the airfoil 302, as shown in FIGS. 8A-C and 8E-F. In FIG. 9, the baffles 902 and the surface 312 of the internal cavity 304 are coated with the wear-resistant coating 314 to prevent or otherwise reduce wear encountered by the baffles 902 and the surface 312 as a result of friction produced by the dilatant material 310 moving in the internal cavity 304.

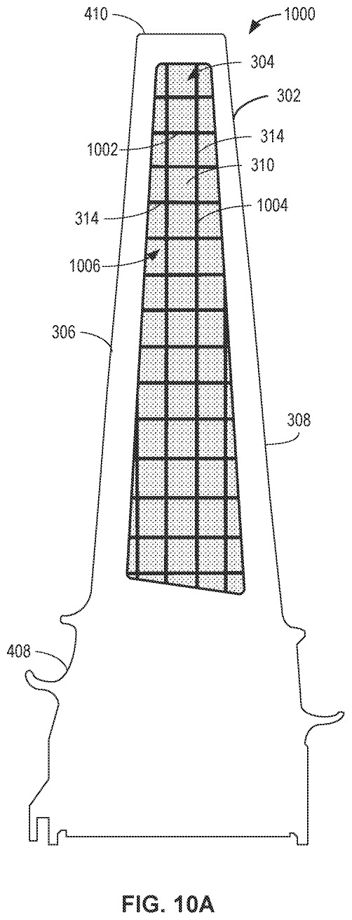

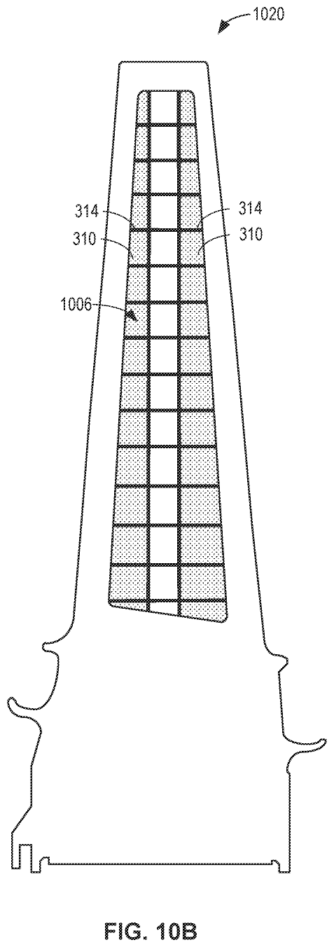

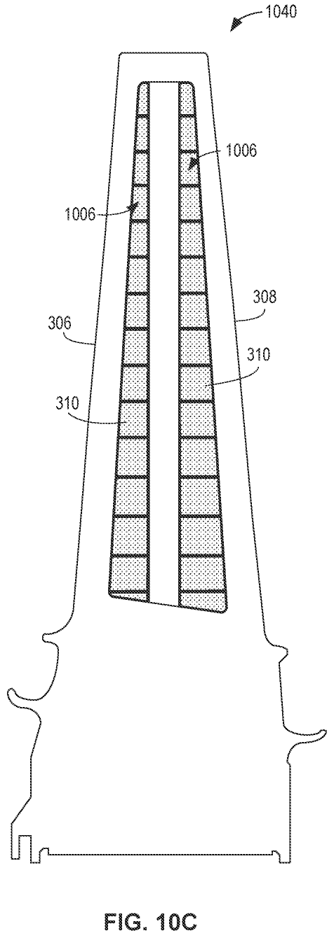

FIG. 10A illustrates a side view of a seventeenth example airfoil damping apparatus 1000. In FIG. 10A, the airfoil 302 includes first walls 1002 coupled to the leading edge 306 and the trailing edge 308 of the airfoil 302. In FIG. 10B, the airfoil 302 includes second walls 1004 coupled to the root portion 408 and the tip portion 410 of the airfoil 302. Accordingly, the first walls 1002 and the second walls 1004 intersect to define cells 1006 to contain the dilatant material 310. The first walls 1002 and the second walls 1004 are coated with the wear-resistant coating 314

In FIG. 10A, the dilatant material 310 is positioned in each of the cells 1006. In some examples, the dilatant material 310 is not positioned in one or more of the cells 1006. For example, FIG. 10B illustrates an eighteenth example airfoil damping apparatus 1020 in which the dilatant material 310 only fills the cells 1006 that border the leading edge 306 and the trailing edge 308 of the airfoil 302. Accordingly, the cells 1006 that do not include the dilatant material 310 may not be coated with the wear-resistant coating 314.

In FIG. 10A, the cells 1006 are positioned throughout the internal cavity 304. In some examples, only a portion of the internal cavity 304 includes the cells 1006. For example, FIG. 10C illustrates a nineteenth example airfoil damping apparatus 1040. In FIG. 10C, the cells 1006 are only located against the leading edge 306 and the trailing edge 308 of the airfoil 302. In FIG. 10C, the dilatant material 310 provides localized vibration damping at the leading edge 306 and the trailing edge 308 of the airfoil.

The foregoing examples of airfoil damping apparatus can be used in turbofan engines. Although each example airfoil damping apparatus disclosed above has certain features, it should be understood that it is not necessary for a particular feature of one example airfoil damping apparatus to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

In some examples, an apparatus includes means for producing aerodynamic forces. For example, the means for producing may be implemented by airfoils, such as the airfoil 302.

In some examples, an apparatus includes means for thickening in response to encountering shear forces, the means for thickening to dampen vibrations encountered by the means for producing aerodynamic forces. For example, the means for thickening may be implemented by dilatant materials, such as the dilatant material 310.

In some examples, an apparatus includes means for resisting wear between the means for thickening and the means for producing aerodynamic forces. For example, the means for resisting may be implemented by the wear-resistant coating 314. In some examples, the means for resisting wear includes titanium, aluminum, and/or cobalt. In some examples, the means for resisting wear includes titanium-aluminum-chromium, titanium-aluminum-chromium-yttrium-silicon, titanium-aluminum-niobium-tantalum, cobalt-molybdenum-chromium, and/or cobalt-chromium-tungsten-nickel. In some examples, the means for resisting wear includes one or more high entropy alloys and/or a bulk metallic glass.

In some examples, an apparatus includes means for directing flow of the means for thickening positioned within the means for producing. For example, the means for directing flow may be implemented by the nested lattice structure 402, the baffles 502, the perforations 504, the baffles 602, the chordwise walls 702, the perforations 706, the baffles 802, the walls 862, the baffles 902, the first walls 1002, and/or the second walls 1004.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

From the foregoing, it will be appreciated that example airfoils have been disclosed that dampen encountered vibrations. The example airfoils include a cavity and a dilatant material (e.g., a shear-thickening fluid) disposed in the cavity to reduce a magnitude of vibrations encountered by the airfoil. Specifically, the dilatant material thickens when the airfoil encounters shear stresses as a result of vibrations. In turn, the dilatant material stiffens and exerts forces that oppose the vibrating motion of the airfoil to stabilize the airfoil. In some examples, the example airfoils include internal structures, such as baffles and/or lattice structures, to direct a flow of the dilatant material and, in turn, control stabilizing forces provided by the dilatant material. In some examples, the example airfoils include cells or sub-cavities to contain the dilatant material within a portion of the airfoil that is less stable and/or encounters increased magnitudes of shear stress when the airfoil encounters unsteady aerodynamic forces.

Example airfoil damping apparatus are disclosed herein. Further examples and combinations thereof include the following:

An apparatus comprising a metallic airfoil including a cavity, and a dilatant material disposed in the cavity to dampen vibrations of the metallic airfoil.

The apparatus of any preceding clause, further including a wear-resistant coating surrounding the dilatant material.

The apparatus of any preceding clause, wherein the wear-resistant coating includes at least one of titanium, aluminum, or cobalt.

The apparatus of any preceding clause, wherein the wear-resistant coating includes at least one of titanium-aluminum-chromium, titanium-aluminum-chromium-yttrium-silicon, titanium-aluminum-niobium-tantalum, cobalt-molybdenum-chromium, or cobalt-chromium-tungsten-nickel.

The apparatus of any preceding clause, further including baffles positioned in the cavity to direct flow of the dilatant material.

The apparatus of any preceding clause, further including a first lattice structure in the cavity, a second lattice structure positioned around the first lattice structure to define a passageway, the dilatant material disposed in the passageway, a first wear-resistant coating on a surface of the first lattice structure to separate the dilatant material from the first lattice structure, and a second wear-resistant coating on an interior surface of the second lattice structure to separate the dilatant material from the second lattice structure.

The apparatus of any preceding clause, wherein the dilatant material includes solid particles suspended in a fluid.

A turbofan engine comprising a hollow fan blade, a shear-thickening fluid disposed in the hollow fan blade, and a wear-resistant coating between the shear-thickening fluid and an interior surface of the hollow fan blade.

The turbofan engine of any preceding clause, further including baffles disposed in the hollow fan blade, the wear-resistant coating to cover the baffles.

The turbofan engine of any preceding clause, wherein the baffles are perforated.

The turbofan engine of any preceding clause, further including chordwise cavities disposed in the hollow fan blade, the shear-thickening fluid disposed in at least one of the chordwise cavities.

The turbofan engine of any preceding clause, further including baffles positioned in the chordwise cavities.

The turbofan engine of any preceding clause, further including radially oriented cavities disposed in the hollow fan blade, the shear-thickening fluid disposed in at least one of the radially oriented cavities.

The turbofan engine of any preceding clause, further including baffles positioned in the radially oriented cavities.

The turbofan engine of any preceding clause, further including first baffles positioned in a first portion of the hollow fan blade, the first portion of the hollow fan blade including the shear-thickening fluid, and second baffles positioned in a second portion of the hollow fan blade, the second portion of the hollow fan blade including air.

The turbofan engine of any preceding clause, wherein the wear-resistant coating is between the first baffles and the shear-thickening fluid in the first portion of the hollow fan blade.

The turbofan engine of any preceding clause, wherein the wear-resistant coating includes at least one of titanium, aluminum, or cobalt.

The turbofan engine of any preceding clause, wherein the wear-resistant coating includes at least one of titanium-aluminum-chromium, titanium-aluminum-chromium-yttrium-silicon, titanium-aluminum-niobium-tantalum, cobalt-molybdenum-chromium, or cobalt-chromium-tungsten-nickel.

The turbofan engine of any preceding clause, further including cells in the hollow fan blade, the shear-thickening fluid disposed in at least one of the cells.

An apparatus comprising means for producing aerodynamic forces, means for thickening in response to encountering shear forces, the means for thickening to dampen vibrations encountered by the means for producing aerodynamic forces, and means for resisting wear between the means for thickening and the means for producing aerodynamic forces.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
a metallic airfoil including a cavity; and
a dilatant material disposed in the cavity to dampen vibrations of the metallic airfoil.

2. The apparatus of claim 1, further including a wear-resistant coating surrounding the dilatant material.

3. The apparatus of claim 2, wherein the wear-resistant coating includes at least one of titanium, aluminum, or cobalt.

4. The apparatus of claim 2, wherein the wear-resistant coating includes at least one of titanium-aluminum-chromium, titanium-aluminum-chromium-yttrium-silicon, titanium-aluminum-niobium-tantalum, cobalt-molybdenum-chromium, or cobalt-chromium-tungsten-nickel.

5. The apparatus of claim 2, further including baffles positioned in the cavity to direct flow of the dilatant material.

6. The apparatus of claim 1, further including:
a first lattice structure in the cavity;
a second lattice structure positioned around the first lattice structure to define a passageway, the dilatant material disposed in the passageway;
a first wear-resistant coating on a surface of the first lattice structure to separate the dilatant material from the first lattice structure; and
a second wear-resistant coating on an interior surface of the second lattice structure to separate the dilatant material from the second lattice structure.

7. The apparatus of claim 1, wherein the dilatant material includes solid particles suspended in a fluid.

8. A turbofan engine comprising:
a hollow fan blade;
a shear-thickening fluid disposed in the hollow fan blade, the shear-thickening fluid including a first viscosity in response to encountering a first shear strain, the shear-thickening fluid including a second viscosity greater than the first thickness in response to encountering a second shear strain, wherein the first shear strain does not satisfy a threshold, and wherein the second shear strain satisfies the threshold; and
a wear-resistant coating between the shear-thickening fluid and an interior surface of the hollow fan blade.

9. The turbofan engine of claim 8, further including baffles disposed in the hollow fan blade, the wear-resistant coating to cover at least a portion of the baffles.

10. The turbofan engine of claim 9, wherein the baffles are perforated.

11. The turbofan engine of claim 8, further including chordwise cavities disposed in the hollow fan blade, the shear-thickening fluid disposed in at least one of the chordwise cavities.

12. The turbofan engine of claim 11, further including baffles positioned in the chordwise cavities.

13. The turbofan engine of claim 8, further including radially oriented cavities disposed in the hollow fan blade, the shear-thickening fluid disposed in at least one of the radially oriented cavities.

14. The turbofan engine of claim 13, further including baffles positioned in the radially oriented cavities.

15. The turbofan engine of claim 8, wherein a first portion of the hollow fan blade includes the shear-thickening fluid and a second portion of the hollow fan blade includes air.

16. The turbofan engine of claim 15, wherein the wear-resistant coating is between the first baffles and the shear-thickening fluid in the first portion of the hollow fan blade.

17. The turbofan engine of claim 8, wherein the wear-resistant coating includes at least one of titanium, aluminum, or cobalt.

18. The turbofan engine of claim 8, wherein the wear-resistant coating includes at least one of titanium-aluminum-chromium, titanium-aluminum-chromium-yttrium-silicon, titanium-aluminum-niobium-tantalum, cobalt-molybdenum-chromium, or cobalt-chromium-tungsten-nickel.

19. The turbofan engine of claim 8, further including passageways in the hollow fan blade, the shear-thickening fluid disposed in at least one of the passageways.

20. An apparatus comprising:
means for producing aerodynamic forces;
means for thickening in response to encountering shear forces, the means for thickening to change from a first thickness to a second thickness greater than the first thickness in response to encountering a shear strain that satisfies a threshold to dampen vibrations encountered by the means for producing aerodynamic forces; and
means for resisting wear between the means for thickening and the means for producing aerodynamic forces.
